(19) United States
(12) Patent Application Publication
(10) Pub. No.: US 2017/0300629 A1
(43) Pub. Date: Oct. 19, 2017

(54) RESPONDER-AWARE AUTO-TRIGGERING OF TRIAGED CONTACT EVENTS

(71) Applicant: The Emergency Contact Project, Inc., Boulder, CO (US)

(72) Inventors: Edward Ross, Longmont, CO (US); Robert Haxel, Pinecliffe, CO (US); Michael Burrows, Lakewood, CO (US); Paul Weisman, Boulder, CO (US)

(21) Appl. No.: 15/320,144

(22) PCT Filed: Jun. 19, 2015
(86) PCT No.: PCT/US2015/036809

§ 371 Date: Feb. 13, 2017

Related U.S. Application Data
(60) Provisional application No. 62/015,057, filed on Jun. 20, 2014.

(51) Int. Cl. G06F 19/00; H04L 29/08

(52) U.S. Cl. CPC G06F 19/322; H04L 67/12; H04L 67/306

(57) ABSTRACT

Embodiments provide automatic triggering of member-defined, triaged contact protocols according to responder and event types. Embodiments can determine, in response to a communication from a responder to the event, a member involved in the event, a responder type, and an event type, and a corresponding member-defined triage protocol can be selected. In accordance with the selected triage protocol, implementations can automatically contact defined member supporters, communicate defined amounts and types of information (e.g., protected medical information) to the responder, etc. Using such techniques, implementations can protect identities and private information of multiple parties involved in an event, and/or limit the amounts and types of contact available by and between responders and supporters; while still facilitating a ubiquitous connection to the wide universe of people who could potentially respond to an event and providing those responders with important information for responding to the event in a protected manner.

### FIELD

Embodiments relate generally to communications systems, and, more particularly, to automatically triggering of predefined, triaged contact protocols according to responder and event types.

### BACKGROUND

In many scenarios, one or more responders can takes action at the scene of an event involving one or more victims. For example, in a medical emergency, the victim can be an individual needing medical attention, and the responder can be a licensed first responder, a good samaritan, a friend, etc. Similarly, in a non-emergency scenario, like finding a lost object, the victim can be an individual who lost the item, and the responder can be any individual who found the item. In these and other scenarios, the victim may often desire that the responder can contact one or more supporters with special knowledge about the victim and/or knowledge that may be relevant, or even critical, to responding to the event. For example, in a medical emergency, the victim may desire that licensed first responders can quickly access important medical information, and that certain personal contacts be immediately notified of the emergency. However, in other instances (e.g., non-emergencies, other types of responders, etc.), the victim may want to limit access to their medical information, contact information, and/or other personal information. Controlling the flow of such data in a manner that facilitates efficient access to the data when desired, but carefully restricts the flow of that data otherwise, can be fraught with technical, legal, and other difficulties.

### BRIEF SUMMARY

Embodiments described herein include novel techniques for automatically triggering member-defined, triaged contact protocols according to responder and event types. Different triage protocols can be triggered according to a determined responder type (e.g., whether the responder is classified as a registered licensed first responder (LFR), an un-registered LFR, or some other classification), a determined event type (e.g., whether the event is determined to be a medical emergency, a non-medical emergency, a lost-and-found event, etc.), and/or other parameters. The triage protocols can define which sets of third-party supporters to contact, in which orders to contact those supporters, by which contact technology (e.g., by phone, text message, email, etc.) to contact those supporters, what information to authorize for communication to and/or from those supporters, what information to authorize for communication to and/or from the responder, and/or other parameters. In some instances, the responder can be the member or one of the predefined supporters. For example, a person needing medical attention or a lost child can be his or her own responder. Further, in some implementations, one or more predefined supporters can be an entity or a computational supporter. Further, in some instances, the “victim” of the event can be associated with a member, such as a member's relative (e.g., a child), a member's pet, a member's property, etc. Various implementations seek to protect identities and private information (e.g., of the victim, supporters, responders, etc.), and/or limit the amounts and types of contact available by and between responders and supporters, while still facilitating a ubiquitous connection to the wide universe of people who could potentially respond to an event.

According to one set of embodiments, a triage server system is provided for automatic triggering of triaged contact protocols. The system includes: a storage subsystem, an alert triaging subsystem, and a contact handling subsystem. The storage subsystem has stored thereon: a number of member profiles, each associated with at least one of a number of members, each member associated with: a unique member credential; protected medical information; and at least one member supporter, each member supporter associated with a contact profile; a number of triage protocols defined in association with each member profile, each triage protocol associated with one of a number of responder types, one of a number of event types, and the contact profile of at least one member supporter; and a number of identifiers associated with registered first responders. The alert triaging subsystem operates, automatically in response to receiving an event trigger in association with an alert communication received over a communications network from a responder to an event, to: determine, according to the alert communication: an identified one of the number of members as involved in the event; a responder type of the responder; and an event type of the event; and select one of the triage protocols defined in association with the identified member, such that a first triage protocol is selected when the determined responder type indicates a registered first responder and the determined event type indicates an emergency, and a second of the triage protocols is selected when the determined responder type indicates other than a registered first responder or the determined event type indicates other than an emergency, The contact handling subsystem operates, automatically in response to selecting one of the number of triage protocols, to: communicate a notification, to the at least one member supporter associated with the selected triage protocol in accordance with the contact profile of the at least one member supporter, that the identified member is involved in the event; and communicate response information, to the responder, the response information having the protected medical information of the identified member only when the first triage protocol is selected.

According to another set of embodiments, a method is provided for automatic triggering of triaged contact protocols. The method includes: receiving an event trigger at a triage server in association with an alert communication received over a communications network from a responder to an event, the event trigger indicating an identified member involved in the event, an identified responder type associated with the responder, and an identified event type associated with the event; selecting one of a number of triage protocols by the triage server in accordance with the triage information and in response to receiving the event trigger, such that the selected triage protocol is predetermined to be selected when the event trigger indicates the identified member, the identified responder type, and the identified event type; and automatically by the triage server, in response to selecting the selected triage protocol: communicating, to a member supporter, a notification that the identified member is involved in the event, the member supporter pre-indicated by the identified member to be contacted in accordance with the selected triage protocol; and communicating, to the responder, response information generated at least in accordance with the selected triage protocol, such that the response information includes protected medical information only when the responder is a registered first responder according to the identified responder type, and when the event is an emergency according to the identified event type.

### BRIEF DESCRIPTION OF THE DRAWINGS

The present disclosure is described in conjunction with the appended figures:

FIG. 1 shows a block diagram of an illustrative triage server system in context of an event triage environment, according to various embodiments;

FIGS. 2A-2C show illustrative member credentials provided using physical labels, such as a luggage tag, a bracelet, and a bicycle helmet sticker, respectively;

FIG. 3 shows a flow diagram of an illustrative method for selecting an appropriate triage protocol, according to various embodiments;

FIGS. 4A and 4B show flow diagrams for illustrative methods for automatically executing respective triage protocols, according to various embodiments;

FIG. 5 shows an illustrative flow diagram of a method for adding and/or updating certain types of subscriber information;

FIG. 6 shows an illustrative flow diagram of a method for automatically triaging an event according to certain embodiments; and

FIGS. 7A-7C show illustrative smart phone text messaging interfaces being used during an event.

In the appended figures, similar components and/or features can have the same reference label. Further, various components of the same type can be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention can be practiced without these specific details. In some instances, circuits, structures, and techniques have not been shown in detail to avoid obscuring the present invention.

There are many scenarios in which one or more “responders” takes action at a scene involving one or more “victims.” For example, in a medical emergency, the victim can be an individual needing medical attention, and the responder can be a certified responder (e.g., a doctor, fireman, emergency medical technician, trained responder, etc.) or an uncertified responder (e.g., a good samaritan, friend, etc.). In a non-emergency scenario, like finding lost item, the victim can be an individual who lost the item, and the responder can be any individual who found the item. In these and other scenarios, the victim may often desire that one or more “supporters” be contacted, and that, where appropriate, the responder can obtain whatever information they need to address the situation. For example, in a medical emergency, victims may desire to have their emergency contacts informed of the emergency, while also providing licensed first responders with important medical information. However, the victims' desires may, at times, be at odds with various considerations. As one example, certain privacy concerns of the victims, as well as certain legal regimes (e.g., the Health Insurance Portability and Accountability Act of 1996, or HIPAA), may prevent the free flow of victims' medical information (e.g., to good samaritans and even to licensed first responders. As another example, responders and/or supporters may desire to help the victims, while maintaining some control over how they are contacted (e.g., by phone, by email, by text message, etc.) and/or by whom.

A number of conventional approaches attempt to address certain of these concerns. Some conventional approaches are intended only for non-emergency contexts, such as lost-and-found events. For example, users can label items with a name, phone number, address, and/or other information that allows a finder to contact the owner or owner's agent (e.g., parent). Such approaches tend to leave certain personal information of the owner exposed to any finder, and are typically useless in most emergency situations. Other types of conventional approaches focus on emergency contexts. For example, one such approach involves affixing a tag (e.g., a bracelet or the like) on an individual that includes a printed summary of health information, such as allergies and blood type. While these approaches facilitate easy access by responders to victims' health information, the information is made available to everyone who looks at the bracelet without restriction (including anyone who finds or see the bracelet, if it is lost or left unattended), the information is limited to what can fit on the bracelet, and there is typically no way to involve third-party supporters (e.g., to contact friends or relatives). Another emergency event-focused approach involves affixing a tag on an individual that includes a phone number; and only certified responders who call the phone number (and are able to provide certain credentials) are allowed access to personal information (e.g., medical information) of the victim. While such approaches are more secure (information is only available to responders that are cleared by the system) and can provide more information (the content is not limited to the size of the bracelet), such approaches do not provide any information to good samaritans or non-certified first responders, and there is typically no way to involve third-party supporters.

Embodiments described herein include novel techniques for automatically triggering member-defined, triaged contact protocols according to responder and event types. Different triage protocols can be triggered according to a determined responder type (e.g., whether the responder is classified as a registered licensed first responder (LFR), an un-registered LFR, or some other classification), a determined event type (e.g., whether the event is determined to be a medical emergency, a non-medical emergency, a lost-and-found event, etc.), and/or other parameters. The triage protocols can define which sets of third-party supporters to contact, in which orders to contact those supporters, by which contact technology (e.g., by phone, text message, email, etc.) to contact those supporters, what information to authorize for communication to and/or from those supporters, what information to authorize for communication to and/or from the responder, and/or other parameters. In some instances, the responder can be the member or one of the predefined supporters. For example, a person needing medical attention or a lost child can be his or her own responder. Further, in some implementations, one or more predefined supporters can be an entity or a computational supporter. Further, in some instances, the “victim” of the event can be associated with a member, such as a member's relative (e.g., a child), a member's pet, a member's property, etc. Various implementations seek to protect identities and private information (e.g., of the victim, supporters, responders, etc.), and/or limit the amounts and types of contact available by and between responders and supporters, while still facilitating a ubiquitous connection to the wide universe of people who could potentially respond to an event.

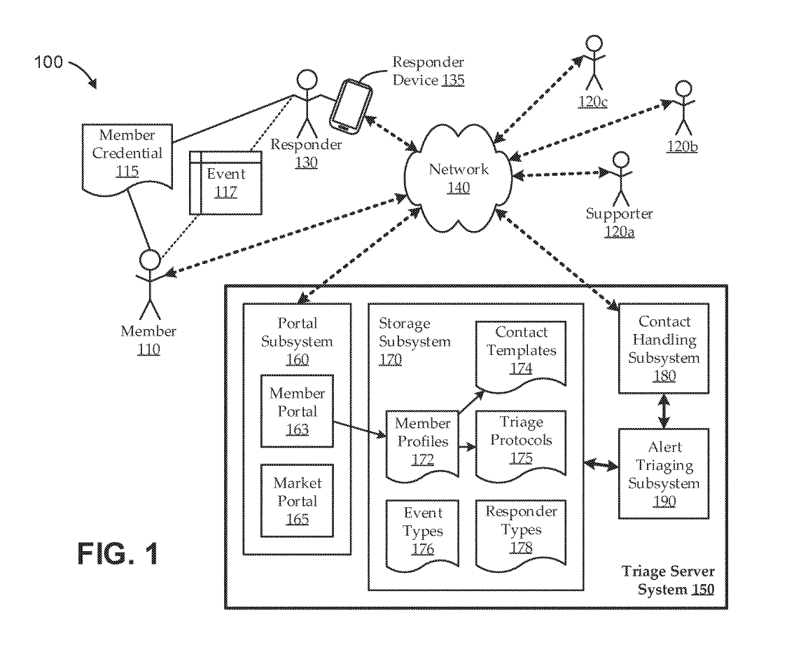

Turning to FIG. 1, a block diagram of an illustrative triage server system 150 is shown in context of an event triage environment 100, according to various embodiments. As illustrated, the event triage environment 100 includes a triage server system 150 that can communicate with multiple parties (members 110, responders 130, and supporters 120) over a communications network 140. For the sake of context, a responder 130 responds to an event 117 involving a victim. For example, the event 117 can be a medical emergency, a non-medical emergency, a non-emergency (e.g., a found object, etc.), etc. It is assumed that at least the victim is also a subscriber to services offered via the triage server system 150, and that the victim-subscriber (i.e., the member 110) has previously set up a member profile 172 stored in a storage subsystem of the triage server system 150.

It is further assumed that the responder 130 to the event encounters a member credential 115. The member credential 115 can include any suitable, sufficiently unique identifier that can be linked to the member 110 at the triage server system 150 and easily obtainable (e.g., human readable or machine-readable with ubiquitous technology) by a responder 130 from a physical medium at the event 117. For example, stickers, labels, tags, bracelets, and/or other physical media can have, integrated thereon (e.g., printed, etched, embedded, embossed, etc.), a barcode, personal identification number (PIN), quick response (QR) code, alphanumeric string, radiofrequency identification (RFID) tag, etc. The credential 115 can be formulated differently for different coverage areas, and/or for other situations. For example, a long-code format can be used for global coverage. In some implementations, the credential includes no (or limited) personal information of the member 110.

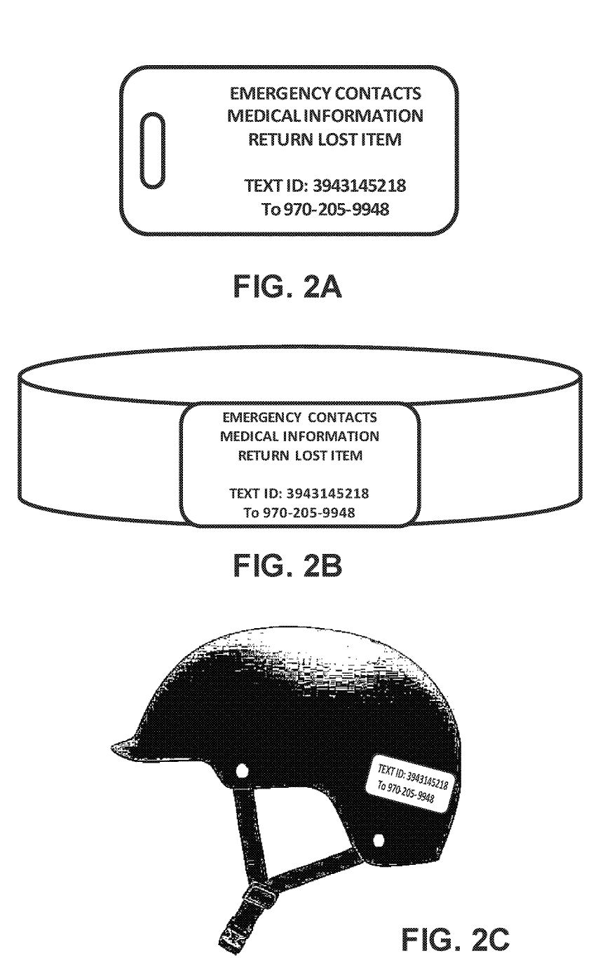

For the sake of illustration, FIGS. 2A-2C show illustrative member credentials 115 provided using physical labels, such as a luggage tag, a bracelet, and a bicycle helmet sticker, respectively. As shown, each physical label can include brief instructions, a text number, and a ten-digit PIN (or any other suitable credential) corresponding to the member credential 115. As explained more fully herein, a responder 130 can text the PIN to the text number, thereby communicating the member credential 115 (and a responder device 135 identifier) to the triage server system 150.

Returning to FIG. 1, as described more fully herein, the member profile can define multiple triage protocols 175 to be automatically selected and executed by the triage server system 150 in response to certain event triggers. Different ones of the triage protocols 175 can be selected according to an identified event type 176, such as whether the event 117 is a medical emergency involving the member 110, a medical emergency involving a party pre-related in the triage server system 150 with the member 110 (e.g., a child, a pet, etc.), a non-medical emergency (e.g., a lost child, a distress call, etc.), a non-emergency (e.g., a found object, a found pet, a disciplinary call from a school, etc.), etc. Some triage protocols 175 can be further selected according to an identified responder type 178, such as whether the responder 130 is a registered licensed first responder (LFR) (e.g., a LFR who previously registered with the triage server system 150), a non-registered LFR, a good samaritan, a registered supporter, etc. For example, different types of responders 130 can be provided with different types of information in different event 117 contexts. Some triage protocols 175 can be further selected according to other criteria. In one implementation, a member 110 can be associated with multiple credentials 115, and the triage protocols 175 can be selected based on which of the credentials 115 is invoked by the responder 130. For example, one credential 115 (e.g., one anonymized alphanumeric string) can be used by the member 110, another can be used by the member's children, another can be used for the member's pet, etc.; and each can be associated at the triage server system 150 with information (e.g., medical information) specific to the target of that credential 115.

The responder 130 can be anyone who responds to the event 117 invoking the member credential 115. As one example, in a medical emergency involving a member 110, an individual may arrive at the scene of the event 117 (or already be present when the event 117 occurs), and may find the member credential 115 on the member's 110 person or property (e.g., on a bracelet worn by the member 110, on the member's 110 bicycle helmet, on a card in the member's 110 wallet, etc.). As another example, an individual may find lost property of a member 110, and the lost property may have the member credential 115 affixed thereon (e.g., on a sticker, label, luggage tag, etc.). In either example, when the individual uses the member credential 115 to respond to the event 117 (as described herein), the individual becomes a responder 130. In yet another example, a child (a member 110, or a dependent of a member 110 that is part of the member profile 172) realizes she is lost, and uses the member credential 115 to initiate a distress alert. In such an example, the member herself (or the dependent) becomes her own responder 130.

Some embodiments can determine a responder type 178. Responder types 178 can include any suitable types of responders 130 that may respond to the event 117. In some implementations, responders 130 fall into two types: certified responders and uncertified responders. For example, responders 130 can be determined to be “certified” either by the responder 130 or a responder's agent pre-registering with the triage server system 150 (e.g., prior to the event) as an individual or as part of a group (e.g., a central registration for all officers of a local police department, etc.), by deriving certifications from a certification authority (e.g., the triage server system 150 can receive information from an accreditation or licensing board or employer), by prompting the responder 130 for relevant information at the time of responding to the event 117 (e.g., asking for a medical license number or asking to affirmatively certify certain licensure or qualification), etc. In such implementations, uncertified responders can effectively be any responder 130 that is not a certified responder. Other implementations can include any suitable number of responder types 178. For example, responders 130 can be classified as certified medical professionals, certified non-medical emergency responders, certified caretakers, etc. As described herein, the responder type 178 determination can be relevant to what types of information are available to that responder 130 (e.g., a subscriber may desire to provide certified medical professionals with access to all medical information, while uncertified responders can only trigger automatic call functions), what information about the responder 130 is provided to others (e.g., whether supporters receive information about the responder 130), etc. The responder type 178 can be determined in any suitable manner (e.g., by the contact handling subsystem 180), for example by prompting for authentication information (e.g., a name, registration number, PIN, cell phone number, etc., which can be looked up in a database of certified responders), by answering certain questions, by responding to one or more certification prompts, by confirming certification with a third party, by determining a pre-registered responder device number (e.g., phone number, etc.), etc.

Some embodiments can also determine an event type 176. Event types 176 can include any suitable types of events 117 that can drive different triage responses (i.e., drive selection and execution of particular triage protocols 175). In some implementations, events 117 fall into two types: emergency events and non-emergency events. For example, a prompt can ask the responder 130 whether the event is an emergency, or the event can be determined to be an emergency in any suitable manner (e.g., by prompting the responders 130 with questions, by comparing the event 130 with other indications of the event received from a dispatcher or other source, etc.). In other implementations, any suitable number 110 and/or type of events 117 can be considered. For example, event types 176 can include medical emergencies (e.g., a responder finds a victim having a broken limb, heart attack, uncertain medical condition, etc.), non-medical emergencies (e.g., a present or remote responder, or the victim him or herself issues an evacuation notice, weather warning, etc.), lost and found events (e.g., a responder 130 finds an object lost by the victim), missing person events (e.g., a responder 130 finds a lost victim, the victim indicates he or she is lost, a remote responder issues a missing persons alert, etc.), maintenance events (e.g., a present or remote responder issues an alert relating to emergency and/or non-emergency maintenance on property), away from home events (e.g., a neighbor or passerby responder alerts the victim property owner of an event at the victims home while the victim is away), threat to property or life events (e.g., a responder 130 or responder-victim issues an alert relating to an imminent threat to property or life), etc. Notably, in various types of events 117, the victim can be the responder 130, the responder 130 can be a supporter 120, etc. Further, in some instances, the responder 130 and/or the victim can be remote from the event 117 (e.g., in the event of a lost object of the victim found by a responder 130). In some implementations, certain types of events can only be triggered by certain types of responders 130. For example, a general emergency event can be elevated to a police emergency by a certified police responder.

According to various embodiments, the responder 130 can respond to an event 117 by providing the located member credential 115 to the triage server system 150 over the network 140 via a responder device 135. The responder device 135 can be a mobile communications device, such as a smart phone, or any other suitable device. The responder 130 can communicate the member credential 115 to the triage server system 150 in any suitable manner according to any suitable communications protocol. In some implementations, the responder 130 uses the responder device 135 to send a text message (e.g., SMS (Short Message Service), MMS (Multimedia Messaging Service), etc.) that includes the member credential 115. The text message can be manually generated by the responder 130, and the member credential 115 can be manually entered. Alternatively, generation of the text message can be automated partially or fully. For example, the member credential 115 can be encoded as a QR code or barcode, which can be scanned by the responder device 135. The scanning can either automatically cause the member credential 115 to be sent to the triage server system 150, or capture the member credential 115 for insertion (or attachment, etc.) in a text message. Similar techniques can be used to send the member credential 115 to the triage server system 150 by email, voicemail, and/or in any other suitable manner.

Some implementations use particular protocols or communications techniques to provide security or other features. To that end, it may be difficult or impossible to “spoof” certain types of communications, so that the triage server system 150 can reliably determine the source of the communication. For example, when a responder 130 sends the member credential 115 by text message to the triage server system 150, the triage server system 150 may be able to reliably identify the originating responder device 135 (e.g., the smart phone number of the responder device 135). Such functionality can provide various features, such as limiting (or at least tracking) nefarious uses of the triage server system 150, verifying the identity of the responder 130, determining a responder type 178 associated with the responder 130, tracking or verifying a responder 130 location, acquiring contact information for the responder 130 to be provided to one or more supporters 120, etc.

In general, embodiments of the triage server system 150 interact with the responder 130 to determine any or all of: a member 110 involved in an event 117; a responder type 178 associated with the responder 130 to the event 117; and an event type 176 associated with the event 117. Based on these determinations, the triage server system 150 can select and execute an appropriate one of a number of triage protocols 175 defined by the member 110 as part of the member profile 172. The member profile 172 can also define a number of supporters 120, including primary contacts, emergency contacts, non-emergency contacts, etc. Each of the supporters 120 can be associated with contact protocols that define, for example, one or more supporter 120 contact numbers (e.g., “contact number” is used generally herein to include phone numbers, email addresses, text numbers, messaging service numbers or handles, etc.), one or more contact formats (e.g., whether to communicate by email using certain text and/or graphical formats, whether to text message using SMS or MMS or some other format, etc.), etc, The triage protocols 175 can be linked (e.g., via the member profile 172) with one or more contact templates 174 that can define who to contact (e.g., one or more supporters 120 and/or the member 110) according to which contact protocols in which types of circumstances, what types of information to provide to those contacts in what types of formats, etc.

As illustrated, implementations of the triage server system 150 can include any or all of a portal subsystem 160, a storage subsystem 170, a contact handling subsystem 180, and an alert triaging subsystem 190. The various functional subsystems can include hardware and/or software component(s) and/or module(s), including, but not limited to circuits, application specific integrated circuits (ASICs), general purpose processors, digital signal processors (DSPs), field programmable gate arrays (FPGAs), programmable logic devices (PLD), discrete gates, transistor logic devices, discrete hardware components, or combinations thereof. For example, steps of methods or algorithms, or other functionality described in connection with embodiments, can be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave. Further, the illustrated network can include any suitable communications network. For example, the network can include any secured and/or unsecured, wired and/or wireless communications links.

Embodiments of the portal subsystem 160 can include any useful functionality for interacting with members 110 (and, in some cases, with registering or registered responders 130). For example, the portal can include a member portal 163 and a market portal 165. The member portal 163 can include user interfaces to facilitate a member 110 registering for one or more services; adding, removing, and/or otherwise editing personal information of the member 110 (e.g., medical information, health records, demographic information, address, contact information, billing information, etc.); adding, removing, and/or otherwise editing information of supporters 120 (e.g., contact details and/or preferences for friends, relatives, care providers (doctors, residence care attendants, babysitters, school personnel, etc.), and/or others); adding, removing, and/or otherwise editing contact templates 174; adding, removing, and/or otherwise editing responder types 178 and/or event types 176; etc. In some implementations, certain interface functions are enabled or disabled depending on certain preferences, subscription type, and/or other factors. For example, a base level of service may allow certain functions to be accessed (e.g., only five supporters can be added, and only default templates can be used), while a higher level of service may allow additional functions to be accessed (e.g., unlimited supporters can be added, and templates are fully customizable). In some implementations, the member portal 163 permits registration of one or more dependents of a member 110, such as the member's spouse, children, pets, etc. Such functionality is intended to be construed broadly to include any suitable type of relationship with a member 110 and/or to include implementations as groupings of members 110 (rather than as dependents). Various implementations permit some or all of the subscriber-defined information to be provided in a highly flexible manner (e.g., many preferences can be controlled by the subscriber 110), in a highly inflexible manner (e.g., limited to default values, even though described as “subscriber-defined”), and/or in other manners (e.g., based on templates and/or default values, but having any suitable amount of flexibility).

Some implementations also permit registration by licensed first responders (LFRs), which is intended broadly herein to include emergency medical technicians, firemen, and/or any other suitable type of responder 130. For example, part of the LFR registration can include signing various waivers and/or certification forms. In some implementations, the registration process includes validation of certifications and/or other credentials of the LFR to be able to receive certain types of information, such as certification to receive protected medial information of a member 110 in case of an emergency (e.g., medical information protected by HIPAA). The registration can be performed by the responder 130 or a responder agent (e.g., some implementations allow a fire department to register all its fire fighters, or the like). Once registered (i.e., as a “registered LFR”) the triage server system 150 can store some identifier of the registered LFR. For example, the triage server system 150 can store a responder device 135 number (e.g., the phone number) associated with that responder 130, or a code or credential associated with the responder 130 (e.g., a PIN, biometric, barcode, voiceprint, etc.). As described herein, the identifier can be provided by the registered LFR-responder 130 to indicate to the triage server system 150 that the responder 130 is pre-authorized to receive protected information.

The market portal 165 can provide a marketplace for products and/or services relating to membership, payment portals for those products and/or services, etc. Some implementations facilitate purchase of tiers of service, offer various services a la carte, etc. For example, one tier of service may only limited (e.g., emergency only) triage protocols 175, limited numbers of supporters 120, etc. Similarly, implementations may offer pre-paid services (e.g., a pre-paid quantity of event triggers, or the like) and/or gift cards for other members 110, etc. Other implementations facilitate purchase of products (e.g., labels) that provide the member credential 115 to a potential responder 130. For example, the marketplace may facilitate purchase of stickers, luggage tags, bracelets, wallet cards, etc.

In some implementations, some or all functions of the triage server system 150 are implemented in one or more server computers. For example, the automatic triage system can be implemented as a cloud-based service, across one or more distributed servers, or otherwise as a software as a service (SaaS) product. The portal subsystem 160 can be accessed in any suitable manner, for example, via a computational device (e.g., a desktop computer, a laptop computer, a tablet computer, a smart phone, etc.). Alternatively (or additionally), functions of the portal subsystem 160 and/or other functions of the triage server system 150 can be implemented as a client application, an app, a thin client, or in any other suitable manner.

As part of the registration process, subscribers 110 can provide various types of information that can be stored as respective member profiles 172, and the member profiles 172 can be stored in the storage subsystem 170. The storage subsystem 170 can be implemented as server storage, cloud-based storage, remote storage, and/or in any other suitable manner. The storage subsystem 170 can store any suitable information for use by various functions of the triage server system 150 described herein. As illustrated, the storage subsystem 170 can store the member profiles 172, triage protocols 175, contact templates 174, event types 176, responder types 178, etc.

In some embodiments, when a responder 130 communicates with the triage server system 150 regarding an event 117, communications are handled by the contact handling subsystem 180. For example, the contact handling subsystem 180 can include any communications functionality (e.g., network functions, protocol functions, etc.) for communicating via text message, email, phone, and/or any other desired manner. In some implementations, the contact handling subsystem 180 is a separate server that handles the communications and relays them, as appropriate, to and from the other functions of the triage server system 150. For example, the contact handling subsystem 180 communicates with the responder 130 via the responder device 135 to obtain event 117 information, such as an involved member 110 (e.g., based on a located member credential 115), a responder type 178 (e.g., based on the originating responder device 135 number), an event type 176 (e.g., based on input from the responder 130), etc. This information can be provided (e.g., as an event trigger) to the alert triaging subsystem 190. The alert triaging subsystem 190 can triage the event trigger to select and execute an appropriate triage protocol 175 from the storage subsystem 170 according to the event 117 information. Execution of the triage protocol 175 by the alert triaging subsystem 190 can include directing the contact handling subsystem 180 to contact the responder 130 and one or more supporters 120 (and/or the member 110) in accordance with the contact templates 174 linked to the triage protocol 175).

According to one embodiment, the triage server system 150 includes the storage subsystem 170, the alert triaging subsystem 190, and the contact handling subsystem 180. The storage subsystem 170 has, stored thereon: member profiles 172, each associated with at least one of a number of members 110 (each associated with a unique member credential 115, protected medical information, and at least one member supporter 120, each member supporter 120 associated with a contact profile); a number of triage protocols 175 defined in association with each member profile 172, each triage protocol 175 associated with one of a number of responder types 178, one of a number of event types 176, and the contact profile of at least one member supporter 120; and a number of identifiers associated with registered first responders. The alert triaging subsystem 190 operates, automatically in response to receiving an event trigger in association with an alert communication received over the communications network 140 from a responder 130 to an event 117, to: determine, according to the alert communication, an identified member 110 (i.e., the member 110 involved in the event 117), a responder type 178 of the responder 130, and an event type 176 of the event 117; and select one of the triage protocols 175 defined in association with the identified member 110, such that a first triage protocol 175 is selected when the determined responder type 178 indicates a registered LFR and the determined event type 176 indicates an emergency, and a second of the triage protocols 175 is selected when the determined responder type 178 indicates other than a registered LFR (e.g., a good samaritan or a non-registered LFR) or the determined event type 176 indicates other than an emergency (e.g., a found object, etc.). The contact handling subsystem 180 operates, automatically in response to the alert triaging subsystem 190 selecting the triage protocol 175, to: communicate a notification, to the at least one member supporter 120 associated with the selected triage protocol 175 in accordance with the contact profile of the at least one member supporter 120, that the identified member 110 is involved in the event 117; and communicate response information, to the responder 130, the response information including the protected medical information of the identified member 110 only when the first triage protocol is selected (i.e., when the responder 130 is a registered LFR and the event 117 is an emergency).

As described herein, the alert triaging subsystem 190 can trigger an appropriate triage protocol 175 based on event 117 information. For example, triage protocols 175 (and/or contact templates 174) can be a defined set of rules and system actions. In one example, six illustrative triage protocols 175 are defined to invoke respective contact templates 174 in accordance with identified responder type 178 and event type 176 as follows:

| Responder Type 178 | Event Type 176 | Contact Template 174 |
|---|---|---|
| Citizen Non-Member | Emergency-Medical | A |
| Licensed EMS | Emergency-Medical | B |
| Citizen Non-Member | Lost and Found | C |
| Licensed EMS | Lost and Found | D |
| School Official | Emergency-Check In | E |
| School Official | Lost and Found | F |

Further to the above example, three of the illustrative contact templates 174 (“A”, “B”, and “C” in the table above) can be defined as follows:

| Contact | |
|---|---|
| Template | |
| 174 | Template Actions/Descriptions |
| A | Supporters for subscriber receive an |
| | email and SMS message. Cellular |
| | phone number for citizen responder, |
| | non-member is provided to |
| | supporters; supporters are advised |
| | that member is the subject of an |
| | emergency alert event. Supporters |
| | receive subject member report: Last |
| | Picture, Medical Information, Allergies, |
| | and the other contacts, contact |
| | information. Citizen responder is told |
| | they will be contacted by an |
| | emergency contact for subject member. |
| B | An alert is triggered by a licensed first |
| | responder and identified as such by |
| | the triage system. A supporter designated |
| | as Primary receives the phone |
| | number of the licensed first responder. |
| | The Primary also receives an email |
| | with all of the subscriber's information. |
| | Non-primary supporters receive a |
| | notification that the subscriber has an |
| | active alert triggered by a licensed |
| | first responder. The non-primary |
| | supporters are not given the licensed |
| | first responder's phone number but |
| | they are invited to contact the |
| | Primary supporter for more information. |
| | The non-primary supporters |
| | receive the subscriber's information |
| | (medical, picture, etc), in order to |
| | support the subscriber in case the Primary |
| | supporter needs their support. |
| | The Licensed First Responder receives |
| | all the primary and non-primary |
| | supporter phone numbers and receives |
| | the subscriber's information: |
| | Picture, Medical information, etc. |
| C | A citizen non-member finds a lost article |
| | with an identification sticker |
| | belonging to a subscriber. The citizen |
| | sends an SMS to the triage system |
| | along with the PIN on the lost item. |
| | The supporters designated for Lost |
| | and Found for the subscriber receive a |
| | message with the phone number of |
| | the citizen responder and a message |
| | indicating that a lost item has been found. |

Some implementations control the flow of information in a manner that seeks to ensure desired levels of privacy for the victim (e.g., member 110 or member-dependent), responder 130, and/or supporters 120. For example, some members 110 may desire to keep certain information private and/or certain information may be governed by privacy or security regimes (e.g., communication of medical information can fall within regulatory controls, such as the Health Insurance Portability and Accountability Act (HIPAA)). For the sake of illustration, suppose the victim-subscriber is a child who is badly injured while at school, and the responder is one of a volunteer, the child's teacher, or an emergency medical technician (EMT). Each possible responder 130 can receive different types of information and/or have a different experience with the triage server system 150. For example, the volunteer sees a bracelet on the child that has a text number and PIN. The volunteer texts the PIN to the text number and receives a prompt (e.g., by return text) asking if this is a medical emergency. The volunteer answers in the affirmative (e.g., again by return text), thereby triggering a triage protocol 175 associated with an uncertified responder in a medical emergency. In accordance with the triage protocol 175, the child's parents are automatically called, an ambulance is dispatched to the school, and a text is sent to the volunteer responder 130 indicating only that appropriate contacts have been notified and an ambulance is on the way. In the case of the teacher as the responder 130, the teacher sees the same bracelet with the same text number and PIN, and the teacher texts the PIN to the text number and receives a prompt asking if this is a medical emergency. The teacher answers in the affirmative, and the teacher is identified as a pre-certified non-medical responder, thereby triggering an appropriate triage protocol 175. In accordance with the triage protocol 175, the child's parents are automatically called, an ambulance is dispatched to the school, and a text is sent to the teacher indicating that appropriate contacts have been notified, that an ambulance is on the way, and providing the teacher with limited medical information (e.g., allergies to medication) and parent contact details. In the case of the EMT as the responder 130, the EMT again sees the same bracelet with the same text number and PIN and texts the PIN to the text number. Realizing that this is an emergency medical responder (e.g., from the responder's text number or other information), an appropriate triage protocol 175 is triggered for certified medical personnel in a medical emergency. In accordance with the triage protocol 175, the child's parents are automatically called, and a text is sent to the EMT indicating that appropriate contacts have been notified, and providing the EMT with all relevant medical information (e.g., blood type, immunization records, known conditions and allergies, etc.).

It is noted that, in the case of the EMT (or other similar cases), conventional approaches are typically unable to control the flow of medical information. For example, conventional approaches involving bracelets or the like having medical information printed thereon permit anyone who sees the bracelet to have access to the sensitive medical information, even if that individual is not certified or authorized. Some other conventional approaches allow medical professionals to access medical information of the victim, but do not provide the medical professional with any confidence that the victim has authorized such access. Embodiments described herein permit certified medical professionals to access information only according to the preferences of the victim-member. Accordingly, the receiver of information can be assured that the victim has pre-authorized communication of that information.

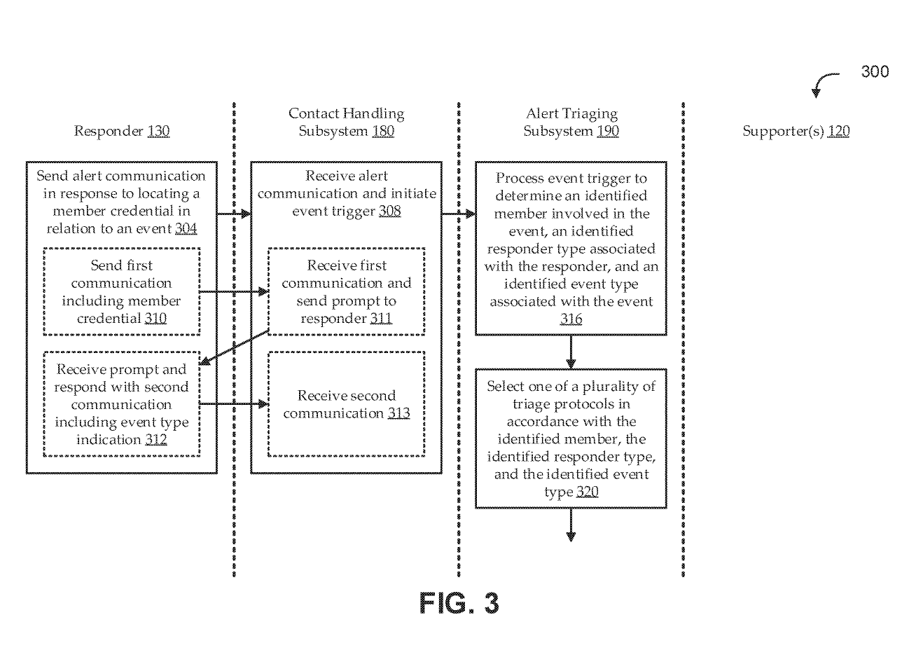

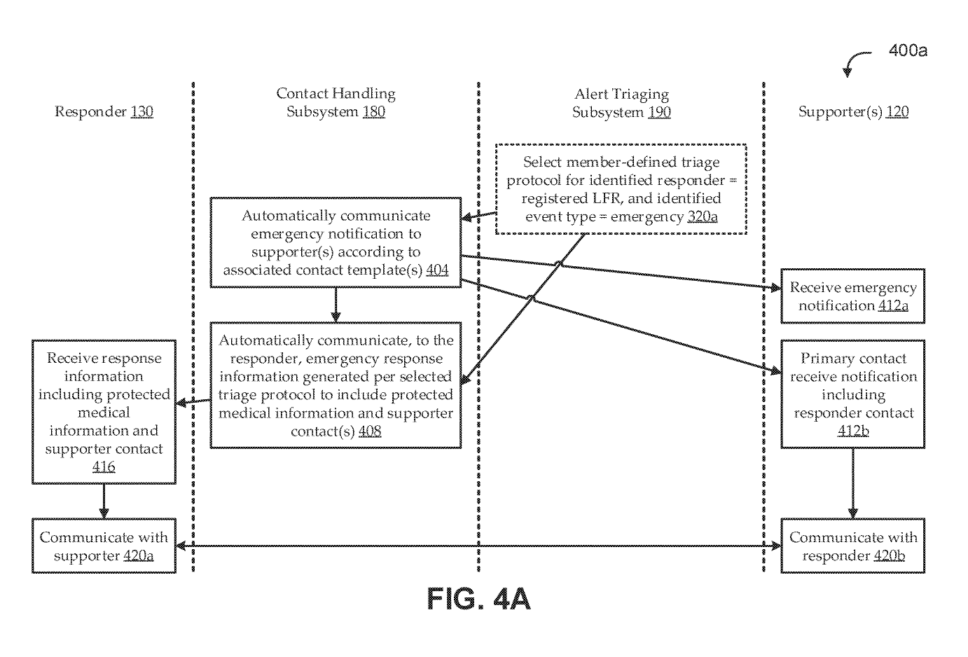

FIG. 3 shows a flow diagram of an illustrative method 300 for selecting an appropriate triage protocol 175, according to various embodiments. For the sake of context, stages of the method 300 are shown as being performed in relation to involved parties (i.e., a responder 130 and one or more supporters 120) and involved subsystems (i.e., a contact handling subsystem 180 and an alert triaging subsystem 190, such as those described above in context of FIG. 1). These involved parties and subsystems are intended to provide added clarity, but are not intended to limit performance of the method 300 to those particular individuals and subsystems.

Embodiments of the method 300 begin at stage 304 by a responder 130 sending an alert communication (e.g., over a communications network to the contact handling subsystem 180) in response to locating a member credential 115 in relation to an event 117. As described above, the responder 130 and/or the member 110 may not be physically present at the scene of the event 117. At stage 308, the alert communication is received (e.g., by the contact handling subsystem 180, and an event trigger can be initiated. In some implementations, multiple communications occur as part of the transactions of stages 304 and 308 (e.g., as shown in stages 310-313). For example, the responder 130 can send a first communication (e.g., text message) that includes the member credential 115 at stage 310. At stage 311, the first communication can be received (e.g., by the contact handling subsystem 180), and a prompt can be sent back to the responder 130 to obtain more information about the event 117 and/or the responder 130. The responder 130 can respond with a second communication that responds to the prompt with relevant information (e.g., an event type 176 indication) at stage 312, and the second communication can be received at stage 313. For example, the first communication can include the member credential 115 and an identifier of the responder device 135; and the contact handling subsystem 180 can identify a member 110 by looking up the member credential 115 and can identify a responder type 178 by looking up the identifier of the responder device 135. The prompt can ask for an event type indicator (e.g. “Respond by text with a ‘1’ if this is an emergency, or with a ‘2’ if you found a lost object”). When the second communication is received, the contact handling subsystem 180 can effectively have enough information to determine a member 110, a responder type 178, and an event type 176 (or information that it can send to the alert triaging subsystem 190 to make those determinations). In some implementations, the prompt (e.g., and/or one or more additional communications) can be used to obtain credentials and/or other information of the responder 130 (e.g., a PIN, biometric, etc.) and/or any other suitable information to assist in triaging the event 117.

At stage 316, the event trigger can be processed (e.g., by the alert triaging subsystem 190) to determine an identified member 110 involved in the event 117, an identified responder type 178 associated with the responder 130, and an identified event type 176 associated with the event 117. For example, the determinations can be made directly from the event trigger (e.g., the event trigger may, itself, include the member 110, event type 176, and/or responder type 178) or the event trigger may include information from which the determinations can be made by the alert triaging subsystem 190 (e.g., the member credential 115 from which the member 110 can be looked up, etc.). At stage 320, one of a number of triage protocols 175 can be selected automatically (e.g., by the alert triaging subsystem 190) in accordance with the identified member 110, the identified responder type 178, and the identified event type 176. In some cases, the triage protocol 175 can be selected only according to the event type 176 or the responder type 178, and not according to both.

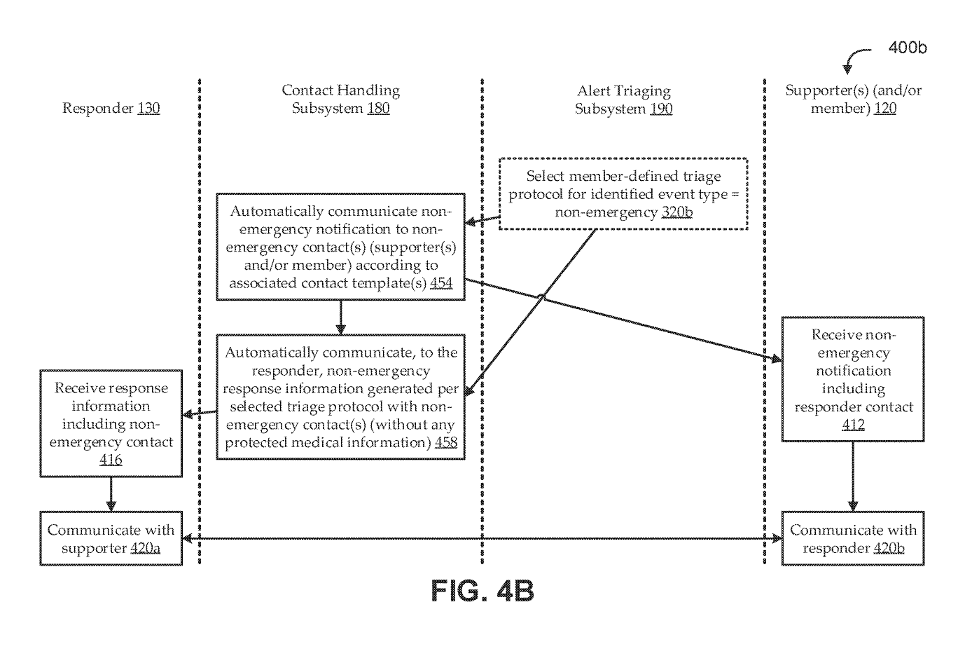

FIGS. 4A and 4B show flow diagrams for illustrative methods 400 for automatically executing respective triage protocols 175, according to various embodiments. The methods 400a and 400b are presented in context of stage 320 of FIG. 3, such that methods 400a and 400b each occur, automatically in response to selecting an appropriate triage protocol 175 for a particular event 117. Further, as in FIG. 3, stages of the methods 400 are shown as being performed in relation to involved parties (i.e., a responder 130 and one or more supporters 120) and involved subsystems (i.e., a contact handling subsystem 180 and an alert triaging subsystem 190, such as those described above in context of FIG. 1). These involved parties and subsystems are intended to provide added clarity, but are not intended to limit performance of the method 300 to those particular individuals and subsystems.

Turning first to FIG. 4A, the provided context of stage 220a indicates that a member-defined triage protocol 175 is selected (e.g., by the alert triaging subsystem 190) in accordance with determining that the identified responder type 178 indicates a registered LFR and the identified event type 176 indicates an emergency. For example, the event 117 may be a medical emergency, and the responder 130 may be an EMT, or the like. The selected triage protocol 175 can be executed, such that, at stage 404, one or more supporters 120 are automatically notified (e.g., by a communication from the contact handling subsystem 180) that the identified member 110 is involved in the event 117. As described above, the contacted member supporter(s) 120 have been pre-indicated by the identified member 110 to be contacted in accordance with the selected triage protocol 175 (in accordance with their respective contact templates 174). Execution of the selected triage protocol 175 can further cause automatic communicating, to the responder 130, of response information generated at least in accordance with the selected triage protocol 175 at stage 408. In this instance, the response information includes protected medical information because the responder 130 has been identified as a licensed emergency responder pre-authorized to receive the protected medical information. The response information can also include contact information for one or more of the contacted supporters 120.

As illustrated, the emergency notification can be received by one or more supporters 120 at stage 412, and the response information can be received by the responder 130 at stage 416. In some instances, one or more of the supporters 120 is identified as a “primary contact,” or the like; and the notification communicated to the primary contact(s) can be received (shown as stage 412b) with additional information, such as a way to contact the responder 130. In some implementations, the responder 130 contact information provided to the primary contact(s) can be the originating number of the responder device 135 or some other phone number, etc. provided by the responder 130 (e.g., previously, as part of registration as a registered LFR; in context of the event 117 as part of the event notification; or in any other suitable manner). The responder contact information can, in some implementations, be anonymized, masked, or otherwise protected. For example, the primary contact can be provided with a phone number to a routing service that routes the call to the responder 130. The same or other techniques can be used for protecting the supporter contact information from the responder 130, if desired. In some instances, the responder 130 may then contact one or more supporters 120 and/or one or more supporters 120 may contact the responder 130, such that the responder 130 and supporter(s) 120 are in communication at stages 420a and 420b. Determinations of how many supporters 120 can contact the responder 130, the permitted contact means, and/or other features driving the communication at stages 420 can be defined by the responders 130 (e.g., as part of a responder profile maintained by the triage server system 150), by the members 110, by the triage server system 150 (e.g., as flexible or inflexible preset conditions), and/or in any other suitable manner. For example, in an emergency event, the responder 130 may be given a primary contact number and one or more backup contact numbers for the primary contact and/or alternate supporter 120 contacts; the primary contact may be given the responder's 130 contact number; and other supporters 120 may be given the primary contact's number.

Turning to FIG. 4B, the provided context of stage 220b indicates that a member-defined triage protocol 175 is selected (e.g., by the alert triaging subsystem 190) in accordance with determining that the identified responder type 178 indicates any type of responder 130 (e.g., a non-registered LFR, a good samaritan), and the identified event type 176 indicates a non-emergency. For example, the event 117 may be a “lost and found” event, and the responder 130 may be any type of responder (in other implementations, the responder type 178 may be relevant to the determination, but it is assumed not to be in this particular example). The selected triage protocol 175 can be executed, such that, at stage 454, one or more supporters 120 (and/or the member 110) are automatically notified (e.g., by a communication from the contact handling subsystem 180) of the non-emergency event 117. As described above, the contacted supporter(s) 120 (and/or member 110) have been pre-indicated by the identified member 110 to be contacted in accordance with the selected triage protocol 175 in accordance with their respective contact templates 174. For example, the case of a found object, the contacted individual may be the member 110, and there may be no reason to contact any additional supporters 120. Execution of the selected triage protocol 175 can further cause automatic communicating, to the responder 130, of non-emergency response information generated at least in accordance with the selected triage protocol 175 at stage 458. In this instance, the response information does not include any protected medical information because such information would not be necessary, and the responder 130 may not have been identified as authorized to receive that information in any case. The response information can include contact information for the member 110 and/or one or more of the contacted supporters 120.

As illustrated, the non-emergency notification can be received by one or more supporters 120 and/or the member 110 at stage 412c, and the non-emergency response information can be received by the responder 130 at stage 416. As illustrated, in some implementations, responder 130 contact information is provided to the non-emergency contact(s) (i.e., the member 110 and/or one or more supporters 120), and/or the non-emergency contact(s) information is provided to the responder 130. As described above, any or all of the contact information can be provided in any suitable manner, including in a protected form. In some instances, the responder 130 may then contact one or more non-emergency contacts, and/or one or more non-emergency contacts may contact the responder 130, such that the responder 130 and non-emergency contacts are in communication at stages 420a and 420b. Determinations relating to communications between the non-emergency contact(s) and the responder 130 can be defined in any suitable manner by any suitable parties.

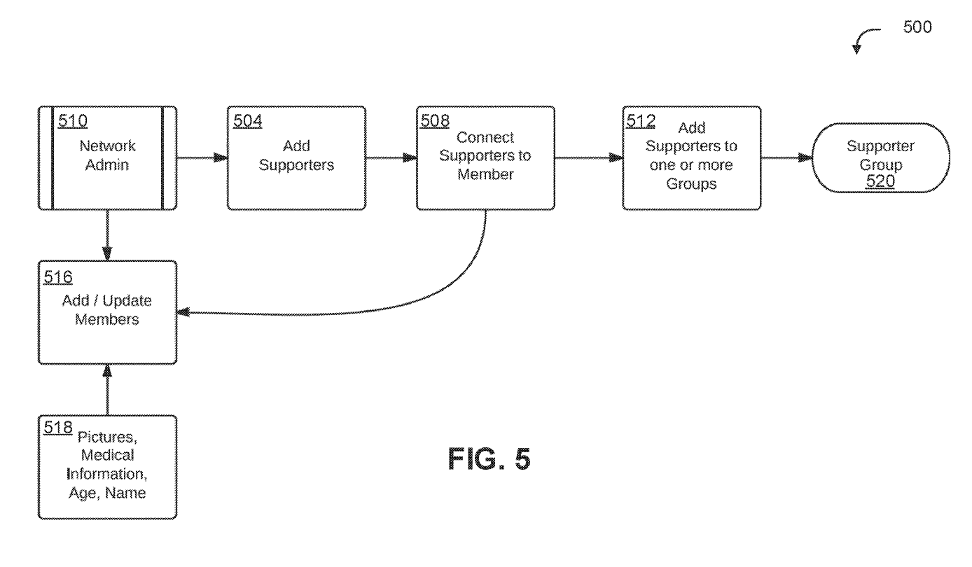

For the sake of added clarity and to illustrate additional functionality, FIGS. 5-7B show flow diagrams for illustrative methods in context of a particular embodiment. FIG. 5 shows an illustrative flow diagram of a method 500 for adding and/or updating certain types of subscriber information. For example, a single account administrator can create and define a private support network for any number of subject members (members 110). Some implementations require that subject members either have given their permission if they are adults or are minors under the care or supervision of the adult. For example, this can ensure compliance with applicable legal or regulatory regimes (e.g., HIPAA). As illustrated, the administrator 510 can define one or more support groups 520 for the subject member. A support group 520 can be a collection of emergency and/or non-emergency contacts that is called into action based on the execution of a specific triage protocol 175 and/or contact template 174. For example, the administrator 510 can add a supporter 120 at stage 504 and connect the supporter 120 to a member 110 at stage 508. Added supporters can then be grouped at stage 512 into supporter groups 520, and the member profile 172 can be updated accordingly at stage 516. The administrator 510 can also associate the same member 110 with any suitable information at stage 518, such as pictures, medical information, age, name, etc.

Some implementations include additional functionality relating to supporters 120. For example, some implementations ensure that each supporter 120 has only one user account. This can help track supporters 120 and let supporters 120 know all the members 110 they are supporting, regardless of how many private support networks 520 they are a part of. This can also facilitate automatic updates (or automatic dissemination and/or inheritance of updates) to their contact information for all members 110 they are supporting. Certain implementations validate supporters 120 as they are added to a private support network 520 (e.g., by checking whether their cell phone and email exist in an account, etc.), which can help mitigate security risks (e.g., mitigating the risk that a “SPEAR PHISHER” can obtain information that would otherwise not be available to the public).

For the sake of illustration, a member 110 adds a supporter 120 by filling out a form with their Name, Email, and Cell number. The member 110 can then be returned to the list of supporters 120, and no data is displayed for the supporter 120 other than an “EC Pending” status, until the supporter 120 is “validated” (e.g., or, in other implementations, limited, selected information can be provided, such as name, cell number, and status). Once validated (e.g., if a match is found), an email is sent to the supporter 120 asking them to accept or decline as a supporter 120. The email has the member's 110 name prominently displayed, along with their email address (e.g., “John Smith—jsmith@gmail.com has requested your support.”). If the supporter 120 accepts, the status of the supporter 120 can be “validated,” but still no additional supporter 120 data is displayed. The member 110 can receive an email validating the supporter 120. If the supporter 120 is not validated (e.g., no match is found), an account can be created for the supporter 120, and an invitation can be sent to the email address provided. Again, the only information displayed is the Name, Cell Number, and Status. Once the supporter 120 confirms, the status can change to validated.

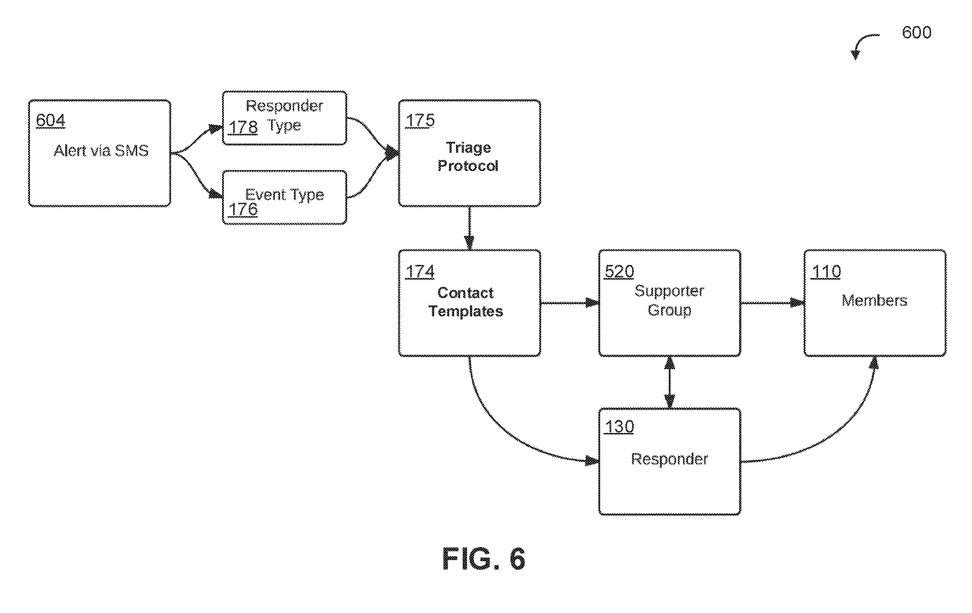

FIG. 6 shows an illustrative flow diagram of a method 600 for automatically triaging an event according to certain embodiments. For example, an alert can be issued by a responder 130 via a text message (or in any other suitable manner) at stage 604. In response to the alert (e.g., event trigger) a determination can be made as to a responder type 178 and an event type 176, and that determination can be used to select and automatically trigger an appropriate triage protocol 175. Member definitions (and/or system defaults or presets) can be used to determine appropriate contact templates 174 corresponding to the invoked triage protocol 175, and communications can be automatically carried out in accordance with the contact templates 174 and triage protocol 175. For example, the contact templates 174 can cause a pre-associated supporter group 520 to be contacted with certain predetermined information, can cause the responder 130 to receive certain predetermined information, can facilitate predetermined types of contact between the responder 130 and supporter groups 520, etc. Some contact templates 174 can also involve sending information to the victim-member 110, facilitating contact with the victim-member 110, etc. Ultimately, the functionality seeks to help the victim-member 110 in the event.

In some implementations, a primary emergency contact, or the like, can set a timer or use a similar technique to trigger the member 110 to send an “OK” or “not OK” status. The trigger also controls which emergency contacts receive the status message. Note that the member 110 can be any member or member dependent (e.g., agent, guardian, child, pet, etc.).

In some implementations, certain triage protocols 175 can only be initiated when proper credentials are first detected. For example, the “I'm OK” alert can be implemented so as to require certain credentials to be accepted (e.g., biometrics, PIN, password, etc.) before communicating the alert to emergency contacts. This can help ensure that nefarious individuals and/or others cannot falsely indicate to supporters 120 that the member 110 is okay. Further, some implementations associate certain triage protocols 175 with communication of sensor data. For example, initiating a certain triage protocols 175 (e.g., the “I'm OK” or “Panic” alert) can cause one or more supporters 120 to receive GPS data of the member 110 or responder's 130 mobile device, to cause the mobile device to take a picture of surroundings, to send a timestamp, etc. This can help one or more supporters 120 locate the member 110, help reconstruct details about the event 117, etc.

Some implementations facilitate “swarm circles” to facilitate cascading circles of support. For example, private support networks 520 can be linked dynamically through supporter-members belonging to multiple private networks 520, so that networks 520 can support each other in the process of supporting an individual protected member 110.

Some implementations facilitate “Last Picture” functionality. For example, the feature can allow a most recent picture to be automatically associated with a member profile 172. The picture can then be made available to supporters 120 and responders 130 in accordance with appropriate event types 176, responder types 178, member preferences, etc. Further, embodiments can include biometric storage, or the like (e.g., the member profile 172 can include iris scans, finger prints, DNA information, etc. Biometrics can be obtained from a victim by responders at a scene of an event (e.g., police, etc.) to see whether the biometrics correspond to a missing persons report, etc.

Some implementations can provide additional services to support particular conditions. For example, immunization records can be included in the member profiles 172, and such information may be accessible to the member 110, authorized officials, etc. Various types of supporting documentation can also be included in the member profiles 172 according to some implementations. For example, in case of certain types of emergencies, a pre-executed medical power of attorney, a living will, a do not resuscitate (DNR) or other directive, and/or other types of documents may be provided, as needed and authorized, to responders 130 and/or other parties (e.g., as a file, as a link, etc.).

Further, some implementations permit a member credential 115 to be tied to one or more other identifiers, temporarily or permanently, so that the other identifier(s) effectively act as a proxy credential. As one example, a runner in a marathon can register her bib number for the race with the triage server system 150, so that entering the bib number would activate the systems in the same way as the member credential 115 during race day (or during some portion of the day). As another example, bundles of service offerings, groups of members, etc. can tie member credentials 115 together to a single identifier as a temporary or permanent proxy credential.

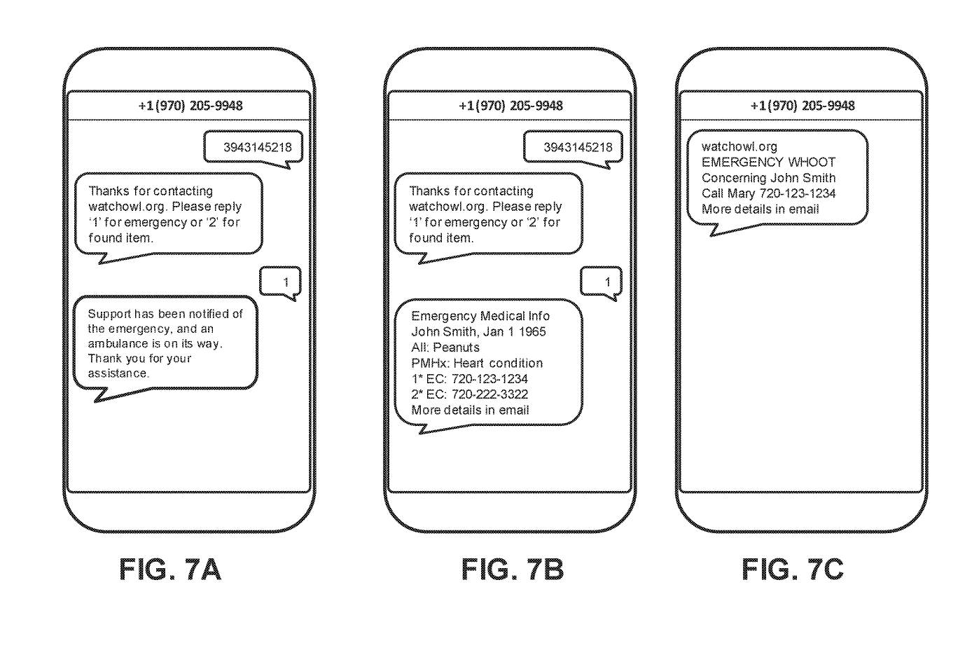

For the sake of illustration, communications between a responder 130 and embodiments of a triage server system 150 during an event 117 can involve various messaging via a text message interface. FIGS. 7A-7C show illustrative smart phone text messaging interfaces being used during an event. In FIG. 7A, a ten-digit PIN associated with the victim is texted to a phone number associated with the automatic triage system. The responder receives a message in response prompting the response for an event type. By responding with ‘1’, the responder indicates that this is an emergency event type. In this scenario, the responder is not authorized to receive any personal information, so a message is returned instead indicating that the emergency is being handled and appropriate supporters have been contacted.

In FIG. 7B, the same ten-digit PIN associated with the victim is texted to the same phone number associated with the automatic triage system. Again, the responder receives a message in response prompting the response for an event type, and again, the responder indicates that this is an emergency event type. In this scenario, the responder is authorized to receive personal information, so the returned message includes important information and indicates that an email has been sent with additional information.

FIG. 7C shows a text interface on a smart phone of one of the secondary emergency contacts who is contacted during an emergency event. The text message is received from the same phone number associated with the automatic triage system. The message indicates that a member they are supporting is the subject of an emergency alert event, and indicates that they can contact a primary emergency contact for more information. The illustrated case in FIG. 7C shows that supporters can be hierarchically arranged (e.g., as primary and secondary) with varying levels of access to information, contact sequence or preference, etc.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims.

The functions described can be implemented in hardware, software, firmware, or any combination thereof. If implemented in software, the functions can be stored as one or more instructions on a tangible computer-readable medium. A storage medium can be any available tangible medium that can be accessed by a computer. By way of example, and not limitation, such computer-readable media can include RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers.

A computer program product can perform certain operations presented herein. For example, such a computer program product can be a computer readable tangible medium having instructions tangibly stored (and/or encoded) thereon, the instructions being executable by one or more processors to perform the operations described herein. The computer program product can include packaging material. Software or instructions can also be transmitted over a transmission medium. For example, software can be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by suitable terminals and/or coupled to servers, or the like, to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized. Features implementing functions can also be physically located at various positions, including being distributed such that portions of functions are implemented at different physical locations.

In describing the present invention, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide. Numerical data can be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

What is claimed is:

1. A triage server system for automatic triggering of triaged contact protocols, the system comprising:
a storage subsystem having stored thereon:
a plurality of member profiles, each associated with at least one of a plurality of members, each member associated with: a unique member credential; protected medical information; and at least one member supporter, each member supporter associated with a contact profile;
a plurality of triage protocols defined in association with each member profile, each triage protocol associated with one of a plurality of responder types, one of a plurality of event types, and the contact profile of at least one member supporter; and
a plurality of identifiers associated with registered first responders;
an alert triaging subsystem that operates, automatically in response to receiving an event trigger in association with an alert communication received over a communications network from a responder to an event, to:
determine, according to the alert communication: an identified one of the plurality of members as involved in the event; a responder type of the responder; and an event type of the event; and
select one of the triage protocols defined in association with the identified member, such that a first triage protocol is selected when the determined responder type indicates a registered first responder and the determined event type indicates an emergency, and a second of the triage protocols is selected when the determined responder type indicates other than a registered first responder or the determined event type indicates other than an emergency; and
a contact handling subsystem that operates, automatically in response to selecting one of the plurality of triage protocols, to:
communicate a notification, to the at least one member supporter associated with the selected triage protocol in accordance with the contact profile of the at least one member supporter, that the identified member is involved in the event; and
communicate response information, to the responder, the response information comprising the protected medical information of the identified member only when the first triage protocol is selected.

2. The system of claim 1, wherein the alert communication comprises the member credential retrieved by the responder from a physical label on property of the identified member.

3. The system of claim 1, wherein the contact handling subsystem further operates to receive the alert communication over the communications network from the responder to the event by:
receiving a first communication from the responder indicating the identified member and the identified responder type;
communicating a prompt to the responder requesting an indication of event type; and
receiving a second communication from the responder indicating the identified event type.

4. The system of claim 3, wherein:
the first communication indicates the identified member by including the member credential;
the first communication includes an originating contact number of the responder; and
the alert triaging subsystem further operates to determine the identified responder type according to the originating contact number of the responder.

5. The system of claim 1, wherein the alert triaging subsystem operates to determine that the responder is of a responder type indicating a registered first responder when the responder is identifiable by the triage server from the alert communication as one of a plurality of licensed first responders pre-registered with the triage server.

6. The system of claim 5, wherein:
the alert communication comprises at least one mobile text message received over the communications network from a mobile device of the responder; and
the responder is identifiable by the triage server as a registered first responder when a phone number of the mobile device matches one of the plurality of identifiers associated with registered first responders stored by the storage subsystem.

7. The system of claim 1, wherein the alert triaging subsystem further operates to select one of the triage protocols defined in association with the identified member, such that:
the second of the triage protocols is selected when the determined responder type indicates other than a registered first responder and the determined event type indicates an emergency; and
a third of the triage protocols is selected when the determined event type indicates other than an emergency.

8. The system of claim 7, wherein the third triage protocol is associated with a lost and found event triggered by a responder finding property of the identified member labeled with the member credential.

9. The system of claim 1, wherein the alert triaging subsystem further operates to select one of the triage protocols defined in association with the identified member, such that:
a third of the triage protocols is selected when the responder is determined to be the identified member, such that the event type indicates a distress alert.

10. The system of claim 1, wherein the alert triaging subsystem is in communication with the contact handling subsystem over the communications network.

11. The system of claim 1, wherein the notification comprises responder contact information usable by the member supporter to contact the responder.

12. The system of claim 1, wherein the response information comprises supporter contact information usable by the responder to contact the member supporter.

13. A method for automatic triggering of triaged contact protocols, the method comprising:
receiving an event trigger at a triage server in association with an alert communication received over a communications network from a responder to an event, the event trigger indicating an identified member involved in the event, an identified responder type associated with the responder, and an identified event type associated with the event;
selecting one of a plurality of triage protocols by the triage server in accordance with the triage information and in response to receiving the event trigger, such that the selected triage protocol is predetermined to be selected when the event trigger indicates the identified member, the identified responder type, and the identified event type; and
automatically by the triage server, in response to selecting the selected triage protocol:
communicating, to a member supporter, a notification that the identified member is involved in the event, the member supporter pre-indicated by the identified member to be contacted in accordance with the selected triage protocol; and
communicating, to the responder, response information generated at least in accordance with the selected triage protocol, such that the response information includes protected medical information only when the responder is a registered first responder according to the identified responder type, and when the event is an emergency according to the identified event type.

14. The method of claim 13, wherein the alert communication comprises a member credential retrieved by the responder from a physical label on property of the identified member, the member credential uniquely associated with the identified member at the triage server.

15. The method of claim 13, wherein the receiving comprises:
receiving a first communication from the responder over the communications network, the first communication indicating the identified member and the identified responder type;
communicating a prompt to the responder over the communications network, the prompt requesting an indication of event type; and
receiving a second communication from the responder over the communications network, the second communication indicating the identified event type.

16. The method of claim 13, wherein each of the plurality of triage protocols is predetermined to be selected by the triage server when the event trigger indicates a respective combination of: one of a plurality of members; one of a plurality of responder types; and one of a plurality of event types.

17. The method of claim 13, wherein the responder is a registered first responder according to the identified responder type when the responder is identifiable by the triage server from the alert communication as one of a plurality of licensed first responders registered with the triage server.

18. The method of claim 17, wherein:
the alert communication comprises at least one mobile text message received over the communications network from a mobile device of the responder; and
the responder is identifiable by the triage server as a registered first responder when a phone number of the mobile device matches one of a plurality of phone numbers stored by the triage server in association with registered first responders.

19. The method of claim 13, wherein:
the member supporter is one of a plurality of member supporters pre-associated with the triage protocol by the identified member;
each member supporter is associated with a stored contact profile that includes a respective contact format and a respective contact destination; and
communicating the notification comprises communicating a respective instance of the notification to each of the plurality of member supporters according to the respective stored contact profiles.

20. The method of claim 19, wherein:
the member supporter is pre-identified by the identified member as a primary contact with respect at least to the selected triage protocol;
the respective instance of the notification communicated to the primary contact includes responder contact information usable by the primary contact to contact the responder; and
the respective instances of the notification communicated to the plurality of member supporters other than the primary contact do not include the responder contact information.
